(19) United States
(12) Patent Application Publication
(10) Pub. No.: US 2018/0274608 A1
(43) Pub. Date: Sep. 27, 2018

(54) BRAKE APPARATUS WITH SINGLE SHOE

(71) Applicants: Won Bong CHO, Hwa Sung city (KR); TAECHUL Industrial Co. LTD, Daegu (KR)

(72) Inventors: Won Bong CHO, Hwa Sung city (KR); Yul Hee LEE, Daegu (KR); Sang Ji LEE, Daegu (KR)

(21) Appl. No.: 15/927,657

(22) Filed: Mar. 21, 2018

(30) Foreign Application Priority Data
Mar. 21, 2017 (KR) 10-2017-0035185

(51) Int. Cl. F16D 51/06; F16D 65/08

(52) U.S. Cl. CPC F16D 51/06; F16D 2121/04; F16D 65/08

(57) ABSTRACT

The present disclosure provides a brake apparatus comprising: a single monolithic brake shoe having a circular shape, wherein the shoe has a spacing defined therein at a predetermined location thereof; an actuator disposed in the spacing, wherein the actuator includes a hollow cylinder an a piston slidably contained in the cylinder, wherein when the actuator is activated, the spacing increases; and a brake lining lined on an outer face of the brake shoe, wherein when the spacing increases, the lining selectively contacts a brake drum, wherein the piston is step-shaped such that a braking force of the brake apparatus having the single monolithic brake shoe is substantially equal to a braking force of a brake apparatus having two individual brake shoes.

### BACKGROUND

Technical Field

The present disclosure relates to a brake apparatus, and more particularly, to a brake apparatus capable of preventing braking stability from deteriorating by disposing an actuator within a spacing defined in a brake shoe formed of a single shoe type.

Discussion of Related Art

Generally, a brake apparatus for a vehicle includes a main brake that decelerates the speed of the vehicle while driving, and a parking brake that stops the vehicle in the stopped state.

In this connection, when decelerating or stopping while driving, or when parking after stopping, a drum type brake mounted on a rear axle is actuated to impart braking force. In such drum type brakes, the brake shoe inside the brake drum is extended and brought into close contact with the brake drum to generate braking force.

A typical brake shoe usually includes two separate sub-shoes. However, a single shoe type brake is formed in a single piece. Such a single type shoe has a rigid structure having a restoring force to allow returning to a state before braking force action when the braking force is released. Therefore, a separate restoring spring is unnecessary.

Such a single shoe type drum brake is mainly mounted on the rear wheel axle of the vehicle. Generally, when the brake acts as a main brake, the brake cooperates with a caliper brake that presses a disk mounted on a front wheel axle. When the integral single type brake acts as a parking brake, the brake operates independently.

However, in a single shoe type main brake, when the number of braking is accumulated, wear of brake lining occurs and wear of brake lining gradually increases. Further, in this situation, the force required to expand the single shoe, which is rigid, increases sharply because the single shoe has to be widened more widely in order to perform braking operation.

Therefore, as the wear of the brake lining progresses, the braking force increases rapidly. In order that the vehicle is slowly decelerated during driving, the caliper brake mounted on the front axle operates, whereas the single shoe brake mounted on the rear axle does not work. Thus, the braking distance is increased. Further, problems such as lowered braking stability, early wear of the brake lining of the caliper brake mounted on the front axle, and lowered braking force may occur. Thus, it is important to reduce the force for expanding the shoe so that the braking starting force may be reduced.

On the other hand, during normal braking, the load of the rear wheel axle is transferred to the front wheel axle, resulting in early lock of the brake on the rear wheel axle. At this time, the brake slips on the rear wheel, thereby causing a spin phenomenon when the braking is invalid.

To prevent this, ABS (anti-lock brake system) is applied to the vehicle. However, when the rear wheel braking force is significantly larger than the normal braking force, there arises a problem that when the main brake is activated, even on an ordinary road other than the slippery freezing road, the rear wheel fixing occurs, and, thus, the ABS is frequently operated.

Further, in order to improve the phenomenon that the ABS is frequently operated, the brake size on the rear wheel axle and thus the braking force thereof may be reduced. However, in this case, the parking brake force is reduced. Thus, the size reduction of the brake may be limited.

### PRIOR ART DOCUMENT

### Patent Literature

Korean Patent Application Publication No. 10-2015-0018938 (Feb. 25, 2015).

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure aims at providing a single monolithic brake shoe having the actuation-force reducing groove formed in the inner face of the brake shoe with a spacing defined therein at a predetermined position to reduce the actuation-initiating force which is, otherwise, rapidly increased due to wear of the brake lining. The expansion and deformation of the brake shoe at the wear of the brake lining occurs from the actuation-force reducing groove, thereby reducing the expansion force for the single shoe type.

The purpose of the present disclosure is to provide a brake apparatus, in which the brake apparatus has a single type shoe to allow removal of anchors that support the leading shoe and trailing shoe, a parking lever and actuator cooperate with each other to increase parking braking force, the boosting is enabled and thus the braking force is amplified when the parking brake is actuated, in using the single shoe type brake as the main brake, a step-shaped actuator is placed in the spacing defined in the brake shoe, such that it is possible to reduce the braking initiation force of the main brake mounted on the rear wheel and prevent the problem that the ABS frequently operates when the brake on the rear wheel shaft prematurely locks.

In a first aspect of the present disclosure, there is provided a brake apparatus comprising: a single monolithic brake shoe having a circular shape, wherein the shoe has a spacing defined therein at a predetermined location thereof; an actuator disposed in the spacing, wherein the actuator includes a hollow cylinder an a piston slidably contained in the cylinder, wherein when the actuator is activated, the spacing increases; and a brake lining lined on an outer face of the brake shoe, wherein when the spacing increases, the lining selectively contacts a brake drum, wherein the piston is step-shaped such that a braking force of the brake apparatus having the single monolithic brake shoe is substantially equal to a braking force of a brake apparatus having two individual brake shoes.

In a second aspect of the present disclosure, there is provided a brake apparatus comprising: a single monolithic brake shoe having a circular shape, wherein the shoe has a spacing defined therein at a first location thereof; an actuator disposed in the spacing, wherein the actuator includes a hollow cylinder and a piston slidably contained in the cylinder, wherein when the actuator is activated, the spacing increases; and a brake lining lined on an outer face of the brake shoe, wherein when the spacing increases, the lining selectively contacts a brake drum; wherein the brake shoe has an actuation-force reducing groove defined therein at a second location thereof, wherein the groove is defined in an inner face of the shoe facing the spacing, wherein the first location is opposite to the second location, wherein the piston is step-shaped such that a braking force of the brake apparatus having the single monolithic brake shoe is substantially equal to a braking force of a brake apparatus having two individual brake shoes.

In one embodiment of the second aspect, the brake shoe has a circumference face portion, and both radially and inwardly extensions from both edges of the face portion respectively, wherein the groove is defined in at least one of the radially and inwardly extensions, wherein when the grooves are defined in the radially and inwardly extensions respectively, the grooves have the same or different depth and/or shape.

In one embodiment of the second aspect, the actuation-force reducing groove has convex and concave portions, or corrugations or is step-shaped or has a rounded shape, wherein a shape of the groove depends on a performance of the brake apparatus.

In one embodiment of the second aspect, a thickness of the shoe is h in a region where the actuation-force reducing groove is not formed, wherein in a region of the actuation-force reducing groove, a thickness of the shoe is h1, wherein a depth of the actuation-force reducing groove is h2, wherein ⅓<h2/h1<3.

In a third aspect of the present disclosure, there is provided a brake apparatus comprising: a single monolithic brake shoe having a circular shape, wherein the shoe has a spacing defined therein at a first location thereof; an actuator disposed in the spacing, wherein the actuator includes a hollow cylinder and a piston slidably contained in the cylinder, wherein when the actuator is activated, the spacing increases; a brake lining lined on an outer face of the brake shoe, wherein when the spacing increases, the lining selectively contacts a brake drum; and a fixing unit configured to prevent an upward movement of the shoe when the actuator is activated and thus the shoe expands, wherein the brake shoe has an actuation-force reducing groove defined therein at a second location thereof, wherein the groove is defined in an inner face of the shoe facing the spacing, wherein the first location is opposite to the second location.

In a fourth aspect of the present disclosure, there is provided a brake apparatus comprising: a single monolithic brake shoe having a circular shape, wherein the shoe has a spacing defined therein at a first location thereof; an actuator disposed in the spacing, wherein the actuator includes a hollow cylinder and a piston slidably contained in the cylinder, wherein when the actuator is activated, the spacing increases; a brake lining lined on an outer face of the brake shoe, wherein when the spacing increases, the lining selectively contacts a brake drum; and a fixing unit configured to prevent an upward movement of the shoe when the actuator is activated and thus the shoe expands, wherein the brake shoe has an actuation-force reducing groove defined therein at a second location thereof, wherein the groove is defined in an inner face of the shoe facing the spacing, wherein the first location is opposite to the second location, wherein the piston is step-shaped such that a braking force of the brake apparatus having the single monolithic brake shoe is substantially equal to a braking force of a brake apparatus having two individual brake shoes.

In a fifth aspect of the present disclosure, there is provided a brake apparatus comprising: a single monolithic brake shoe having a circular shape, wherein the shoe has a spacing defined therein at a first location thereof; and an actuator disposed in the spacing, wherein the actuator includes a hollow cylinder and a piston slidably contained in the cylinder, wherein when the actuator is activated, the spacing increases; wherein the brake shoe has an actuation-force reducing groove defined therein at a second location thereof, wherein the groove is defined in an inner face of the shoe facing the spacing, wherein the first location is opposite to the second location.

In one embodiment of the fifth aspect, the piston include first and second pistons spaced apart from each other, wherein when a hydraulic pressure is generated by an operation of the brake apparatus, each separated end of the single brake shoe via the spacing is pressed by each of the first and second pistons.

In one embodiment of the fifth aspect, combination of diameters of the first and second pistons is configured such that a braking force of the brake apparatus is reduced when the brake apparatus is activated.

In one embodiment of the fifth aspect, the hollow cylinder has an accommodation space defined therein, wherein the space is divided into a first space and a second space arranged in a longitudinal direction of the cylinder, wherein the first and second pistons are slidably received in the first and second spaces respectively, wherein the first piston 421 has an accommodation groove having a predetermined size, wherein the second piston has a reaction-force generation groove formed at a position facing the accommodation groove provided in the first piston, wherein the apparatus further includes a parking lever, wherein the parking lever is configured to allow and control a spacing between the first piston and the second piston during operation of the brake apparatus as a parking brake.

In one embodiment of the fifth aspect, the parking lever includes a first actuation link and a second actuation link, wherein the first actuation link has a predetermined length along a horizontal direction and has one end inserted into the accommodation groove, wherein the second actuation link has a predetermined length along a vertical direction, wherein the second link extends perpendicular to the first actuation link, wherein one end of the second link is operably engaged with the other end of the first link, wherein said one end of the second link is received in the reaction-force generation groove, wherein in an operation of the apparatus as a parking brake, the second link pivots around the other end thereof, thereby pressing the first actuation link, thereby increasing the spacing between the first piston and the second piston.

In one embodiment of the fifth aspect, each of the first and second pistons is step-shaped such that each of the pistons has portions with different diameters.

According to the present disclosure, the actuation-force reducing groove is formed in the inner face of the brake shoe with spacing defined therein at a predetermined position to reduce the actuation-initiating force which is, otherwise, rapidly increased due to wear of the brake lining. The expansion and deformation of the brake shoe at the wear of the brake lining occurs from the actuation-force reducing groove, thereby reducing the expansion force for the single shoe type.

In accordance with the present disclosure, the brake apparatus has a single type shoe to allow removal of anchors that support the leading shoe and trailing shoe; a parking lever and actuator cooperate with each other to increase parking braking force, the boosting is enabled and thus the braking force is amplified when the parking brake is actuated, in using the single shoe type brake as the main brake; a step-shaped actuator is placed in the spacing defined in the brake shoe, such that it is possible to reduce the braking initiation force of the main brake mounted on the rear wheel and prevent the problem that the ABS frequently operates when the brake on the rear wheel shaft prematurely locks.

### BRIEF DESCRIPTION OF THE DRAWINGS

FIG. 1 is a front view of the brake apparatus according to the first embodiment of the present disclosure.

FIG. 2 is a cross-sectional view of the arc of the shoe of the brake apparatus according to the first embodiment of the present disclosure.

FIG. 3 shows a structure for reducing the expansion force of the shoe of the brake apparatus according to the second embodiment of the present disclosure.

FIG. 4 shows the brake apparatus according to the second embodiment of the present disclosure.

FIG. 5 is a cross-sectional view of an arc including a groove configured to reduce the expanding initiating force for the shoe of the brake apparatus according to the second embodiment of the present disclosure.

FIG. 6 is a perspective view of the brake apparatus according to the third embodiment of the present disclosure.

FIG. 7 is a front view of the brake apparatus according to the fourth embodiment of the present disclosure.

FIG. 8 is a sectional view of an arc of the shoe of the brake apparatus according to the fourth embodiment of the present disclosure.

FIG. 9 is a view showing a groove for reducing the expansion force of the shoe of the brake apparatus according to the fifth embodiment of the present disclosure.

FIG. 10 is a graph showing the actuation-initiating force based on the shoe deformation amount for the brake apparatus according to the fifth embodiment of the present disclosure.

FIG. 11 shows the brake apparatus with an auxiliary device for preventing the movement of the shoe groove portion in accordance with the fifth embodiment of the present disclosure.

FIG. 12 is a graph showing the relationship between the shoe deformation amount relative to the lining and the actuation-initiating force in accordance with the present disclosure.

FIG. 13 shows the relationship between a piston actuating force by the actuator and a braking force based on the brake types.

FIG. 14 shows the brake apparatus of the single shoe type according to the sixth embodiment of the present disclosure.

FIG. 15 is a conceptual diagram showing the actuator for the brake apparatus of leading shoe and trailing shoe type according to the prior art.

FIG. 16 shows the operation of the piston in the parking brake operation for the brake apparatus of the single shoe type, according to the sixth embodiment of the present disclosure.

### DETAILED DESCRIPTIONS

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

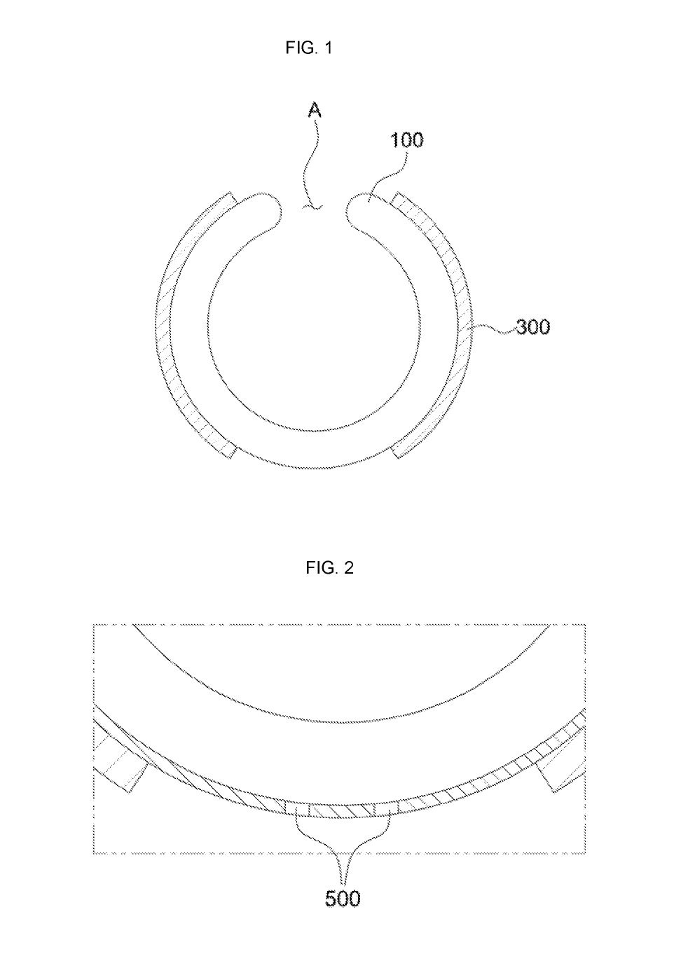

FIG. 1 is a front view of the brake apparatus according to the first embodiment of the present disclosure. FIG. 2 is a cross-sectional view of the arc of the shoe of the brake apparatus according to the first embodiment of the present disclosure. Referring to FIGS. 1 and 2, the integral shoe 100 has a spacing A at a predetermined position. Therefore, one portion thereof is open. A coating liquid drain hole 500 for anti-corrosion of the shoe is provided opposite to the spacing. A braking lining 300 is disposed around an outer face of the shoe.

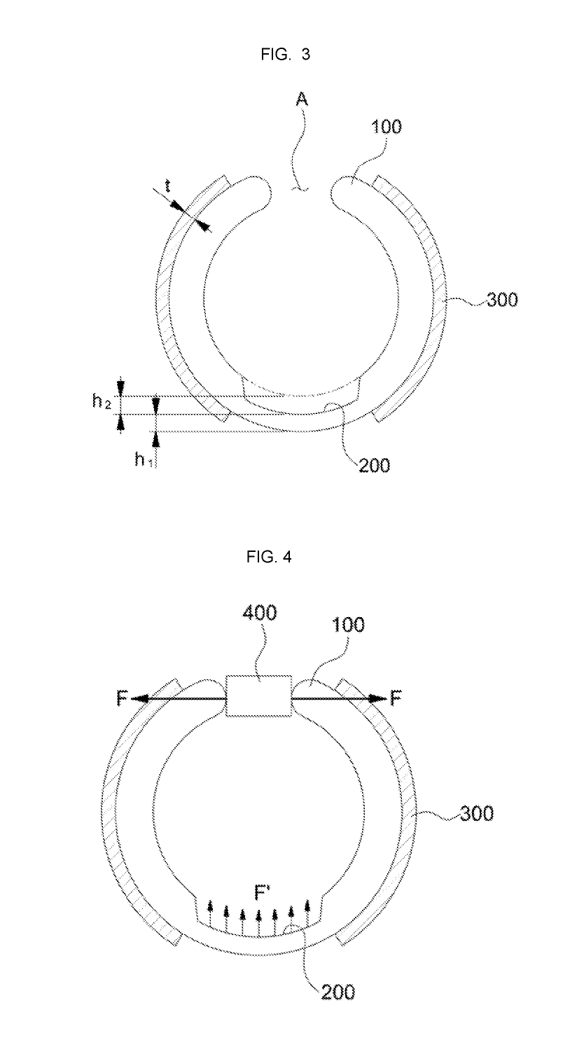

FIG. 3 shows a structure for reducing the expansion force of the shoe of the brake apparatus according to the second embodiment of the present disclosure. Referring to FIG. 3, when the thickness of the brake lining 300 is t, the maximum extension distance of the shoe is 2t.

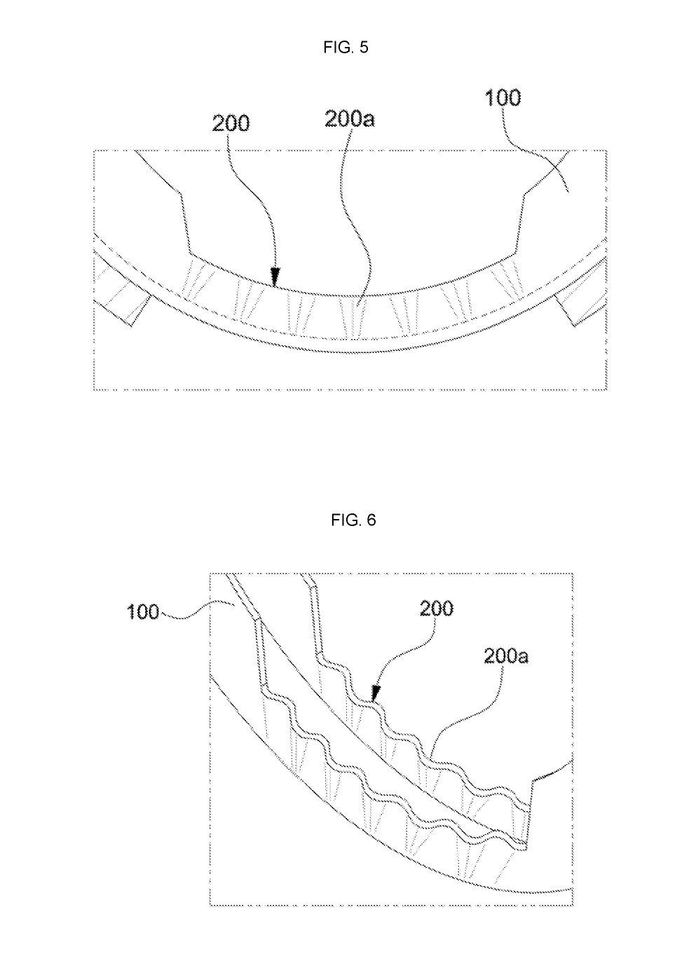

FIG. 4 shows the brake apparatus according to the second embodiment of the present disclosure. FIG. 5 is a cross-sectional view of an arc including a groove configured to reduce the expanding initiating force for the shoe of the brake apparatus according to the second embodiment of the present disclosure.

Further, the actuation-force reducing groove 200 is formed opposite to the spacing defined in the integral shoe. The depth of the actuation-force reducing groove 200 may depend on the performance and conditions of the brake apparatus.

As shown in FIG. 3, the depth of the defined groove h2 should be as large as possible to minimize the shoe expand initiation force as much as possible. In the case of rapid braking, ESC (electronic stability control) and parking braking, a large braking force may be generated. In this connection, as shown in FIG. 4, when expanding the brake shoe 100, an upward deformation force F1 may be generated in the region of the actuation-force reducing groove 200. Accordingly, the region of the actuation-force reducing groove 200 may be plastically deformed such that the brake does not work. In order to prevent this, i.e., to prevent the area of the actuation-force reducing groove 200 from being displaced upward, even during the expansion of the shoe, the fixing unit to be described later is mounted on the support 600.

FIG. 3 shows a structure for reducing the expansion force of the shoe of the brake apparatus according to the second embodiment of the present disclosure. The depth of the defined groove h2 should be as large as possible to minimize the shoe expand initiation force as much as possible.

That is, let the thickness of the shoe be h in a region where the actuation-force reducing groove 200 is not formed. In the region of the actuation-force reducing groove 200, let the thickness of the shoe be h1. Let the depth of the actuation-force reducing groove 200 be h2. Therefore, a relationship of h=h1+h2 is established. In this connection, the ratio h2/h1 is variable depending on the material, shape, shoe expansion force of the shoe. In an embodiment, the following is established: ⅓<h2/h1<3.

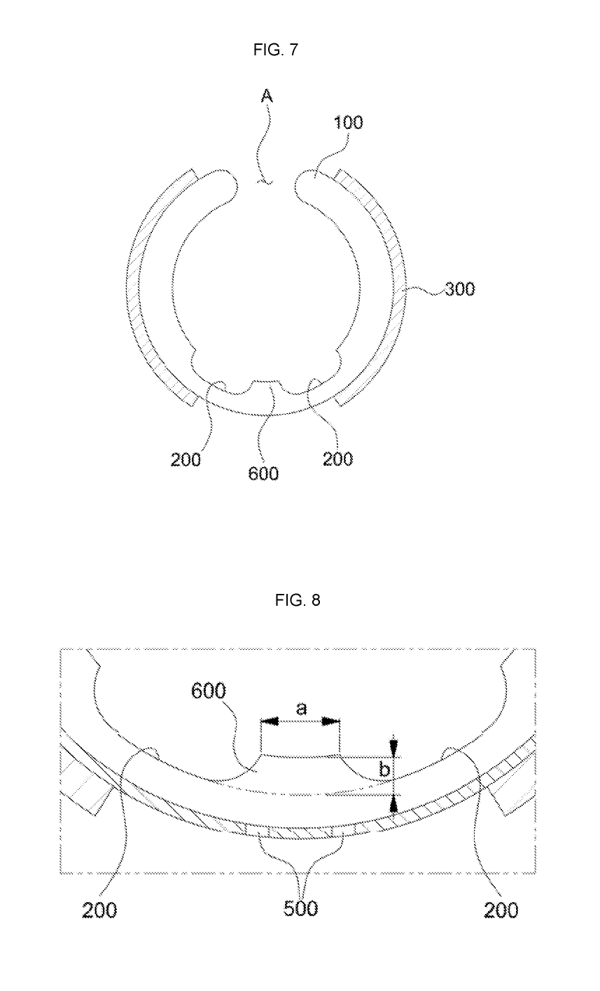

FIG. 6 is a perspective view of the brake apparatus according to the third embodiment of the present disclosure. FIG. 7 is a front view of the brake apparatus according to the fourth embodiment of the present disclosure. Referring to FIG. 6 and FIG. 7, the actuation-force reducing groove 200 has fine convex and concave portions 200a. The actuation-force reducing groove 200 may have roughness. The actuation-force reducing groove 200 may have steps. The actuation-force reducing groove 200 may be formed in an elliptical or arcuate shape. The shapes of the actuation-force reducing groove 200 may vary depending on the performance of the brake. The present invention is not limited to this. The actuation-force reducing groove 200 may be plural or single.

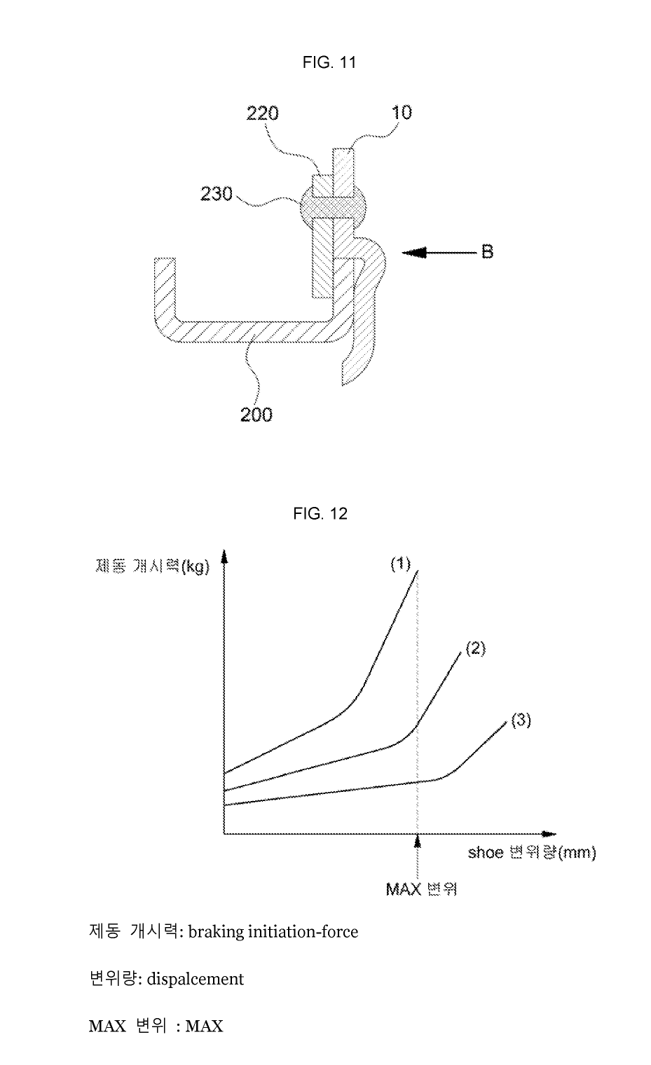

The fixing unit support 600 supports a fixing unit B (see FIG. 11) thereon. Thus, the fixing unit is mounted on the fixing unit support 600. The fixing unit support 600 is formed in the region of the actuation-force reducing groove 200. The fixing unit support 600 has a horizontal length a and a vertical length b (see FIG. 8). The horizontal length a and the vertical length b may be determined by the expansion force of the actuator and the strength of the brake shoe 100.

The actuation-force reducing groove 200 may be configured to reduce the actuating force of the actuator toward the brake shoe 100 during braking. That is, by forming the actuation-force reducing groove 200, in the region of the actuation-force reducing groove 200, the cross-sectional area of the brake shoe 100 is reduced. Thus, in the region of the actuation-force reducing groove 200, the modulus of elasticity of the shoe is reduced. Thereby, upon deformation of the brake shoe 100, the expansion force of the brake shoe 100 may be reduced. The shape or configuration of the actuation-force reducing groove 200 may be configured to be adapted to the degree of reduction of the actuating force of the actuator to be applied.

As shown in FIG. 6, in the region of the actuation-force reducing groove 200, the shoe may have a corrugation 200a. The corrugation 200a is formed along the inner surface of the shoe facing the spacing A. The corrugation 200a may be capable of reducing the expansion force of the brake shoe 100 as described above. The corrugation 200a may include fine convex and concave portions as described above. Therefore, the tensile action is liable to occur in the concave portion. Also, the fine convex and concave portions may act like springs.

The thickness of the brake lining is large. Thus, the thickness of the combination of the brake shoe and the brake lining is thicker in the regions other than the spacing A region. The shoe may be further expanded by this thickness difference. In this case, due to the corrugation 200a, the expansion force of the shoe without plastic deformation may be minimized. Thereby, it is possible to secure a sufficient linear deformation section from the braking force initiation of the brake shoe 100 during braking.

As a result, in this embodiment, due to the actuation-force reducing groove 200 and the corrugation 200a formed on the actuation-force reducing groove 200 as described above, when an expansion force occurs in the brake shoe 100, the corrugation 200a may be extended like a spring. Accordingly, even when wear of the brake lining 300 occurs, the expanding initiation force may be linearly changed from the spacing A as shown in FIG. 12.

FIG. 7 is a front view of the brake apparatus according to the fourth embodiment of the present disclosure. FIG. 8 is a sectional view of an arc of the shoe of the brake apparatus according to the fourth embodiment of the present disclosure.

Referring to FIG. 7 and FIG. 8, the brake apparatus according to the present embodiment includes the brake shoe 100, the actuation-force reducing groove 200, the brake lining 300 and the actuator 400, the drain hole 500, and the fixing unit support 600.

In this connection, the brake shoe 100, the actuation-force reducing groove 200 and the brake lining 300, the drain hole 500, and the fixing unit support 600 in this embodiment have the same configurations as those in the above-described embodiments. Therefore, detailed description of these components will be omitted in this embodiment.

That is, in the above-described embodiment, the structure of the brake shoe 100 is described which enables a sufficient linear deformation region to be secured from the braking force initiation in comparison with the conventional brake apparatus. This brake shoe 100 may be used not only for main brakes but also for parking brakes.

In other words, conventionally, a brake device consisting of two brake shoe, leading shoe and trailing shoe and restoring spring was used as main brake and parking brake. In this prior art, the combination of two brake shoes and restoration springs complicates the structure of the brake system as well as increases the weight and cost of the brake system.

Therefore, in the present embodiment, the spacing A is defined in the integral shoe, and the actuator 400 is installed in the spacing. By actuating the actuator 400 during braking, the spacing A is increased. During travel of the vehicle, the actuation-force reducing groove 200 may allow the shoe to return to the initial position. Thus, a configuration with a separate restoring spring and two brake shoes in the prior art is eliminated. Without such a conventional configuration, the present braking device may be effectively used as a main brake and a parking brake.

As shown in FIG. 3 and FIG. 4, the braking initiation force may be drastically increased due to wear of the brake lining 300 due to its structural characteristics.

In this case, only the caliper brake attached to the front wheel applies a braking force to the wheel. The brake mounted on the rear wheel may not work. As a result, when the lining wear is severe, the brake cannot be used as a main brake and can only be used as a parking brake.

To this end, in the present embodiment, the actuation-force reducing groove 200 is defined on the inner face of the brake shoe 100 facing the spacing A. At the center of the actuation-force reducing groove 200 region, the shoe has a fixing unit support 600 for supporting a fixing unit B (see FIG. 11). Therefore, even when the wear of the brake lining 300 is severe, the actuation-force of the brake shoe 100 can be reduced when the actuator 400 disposed in the space A is operated.

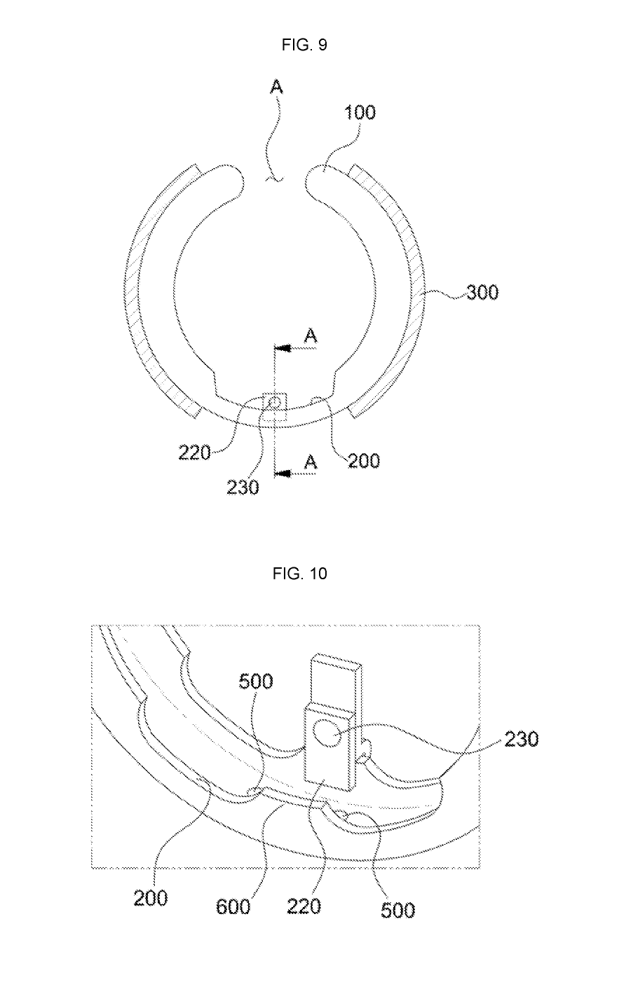

FIG. 9 is a view showing a groove for reducing the expansion force of the shoe of the brake apparatus according to the fifth embodiment of the present disclosure. FIG. 10 is a graph showing the actuation-initiating force based on the shoe deformation amount for the brake apparatus according to the fifth embodiment of the present disclosure. FIG. 11 shows the brake apparatus with an auxiliary or fixing device B for preventing the movement of the shoe groove portion in accordance with the fifth embodiment of the present disclosure. To be specific, FIG. 9 shows the fixing unit support 600 for supporting a fixing unit B. FIG. 11 is a cross-sectional view taken along the line A-A′ in FIG. 9, and FIG. 10 is a perspective view taken along the line A-A′.

Referring to FIGS. 9 and 10 and FIG. 11, in the region of the actuation-force reducing groove 200, in order to prevent the shoe from being deformed upward, in the region of the actuation-force reducing groove 200, the shoe is fixed to the fixing unit B. The fixing unit B is fixed on the fixing unit support 600 having a back plate 10. The fixing unit B includes a body 210, a support plate 220, and a fastener 230.

In this connection, as shown in FIG. 11, in the region of the actuation-force reducing groove 200, the shoe may have a corrugation 200a on the inner surface of the shoe facing the spacing A. The configuration and effect of the corrugation 200a are the same as those of the above embodiment, and a description thereof will be omitted in this embodiment.

The support plate 220 is configured to connect the back plate 10 and the shoe in the actuation-force reducing groove 200 region. The support plate 220 is vertically oriented while being parallel to the upward bent portion of the shoe body 100.

The fastener 230 is preferably implemented as a rivet or bolt. The fastener passes through the support plate 220 and back plate 10. In this way, via the fastener 230, the support plate 220 is secured to the back plate 10 and thus the shoe in the actuation-force reducing groove 200 region.

FIG. 12 is a graph showing the relationship between the shoe deformation amount relative to the lining and the actuation-initiating force in accordance with the present disclosure. In the graph of FIG. 12, (1) denotes that the actuation-force reducing groove 200 is not formed. (2) indicates the case where only the actuation-force reducing groove 200 is formed. (3) indicates the case where the actuation-force reducing groove 200 and the corrugation 200a are defined. In the case of (3) above, a curve of the actuation-initiating force versus the deformation amount of the shoe is more linear than those in the cases of (1) and (2) above. Therefore, in the case of the configuration (3), it is possible to effectively solve the problem that the actuation-initiating force is rapidly increased.

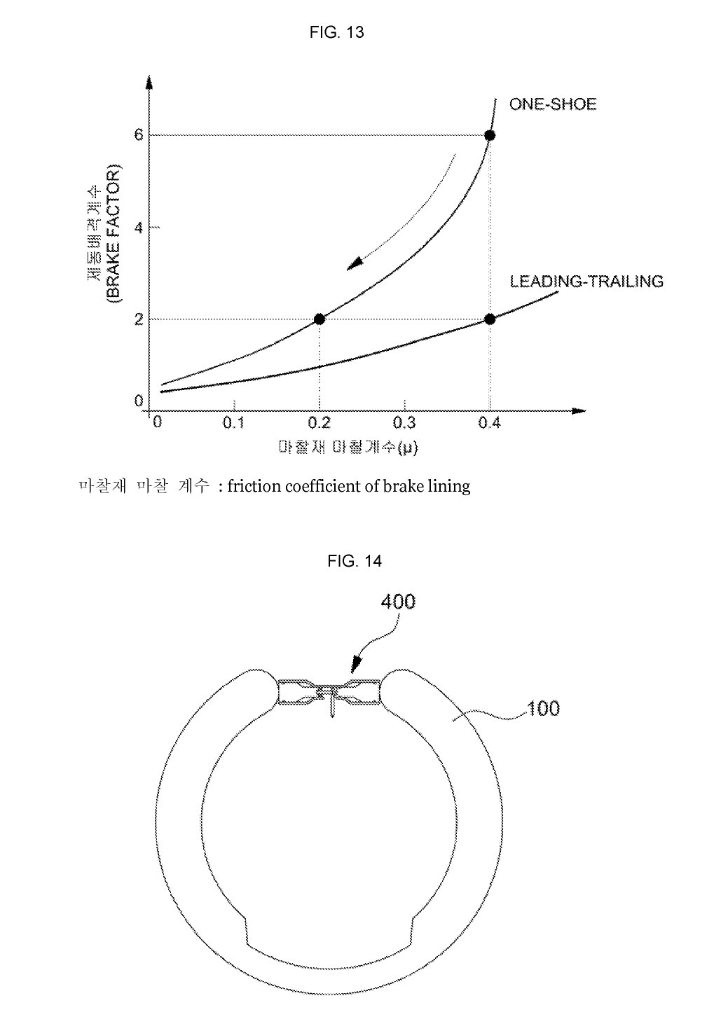

FIG. 13 shows the relationship between a piston actuating force by the actuator and a braking force based on the brake types. The braking force varies with the actuating force of the actuator 400. In the single shoe type brakes, the actuating force of the actuator must be sufficiently reduced such that the braking force thereof has the same level as that of the braking force of the leading and trailing shoe type brakes.

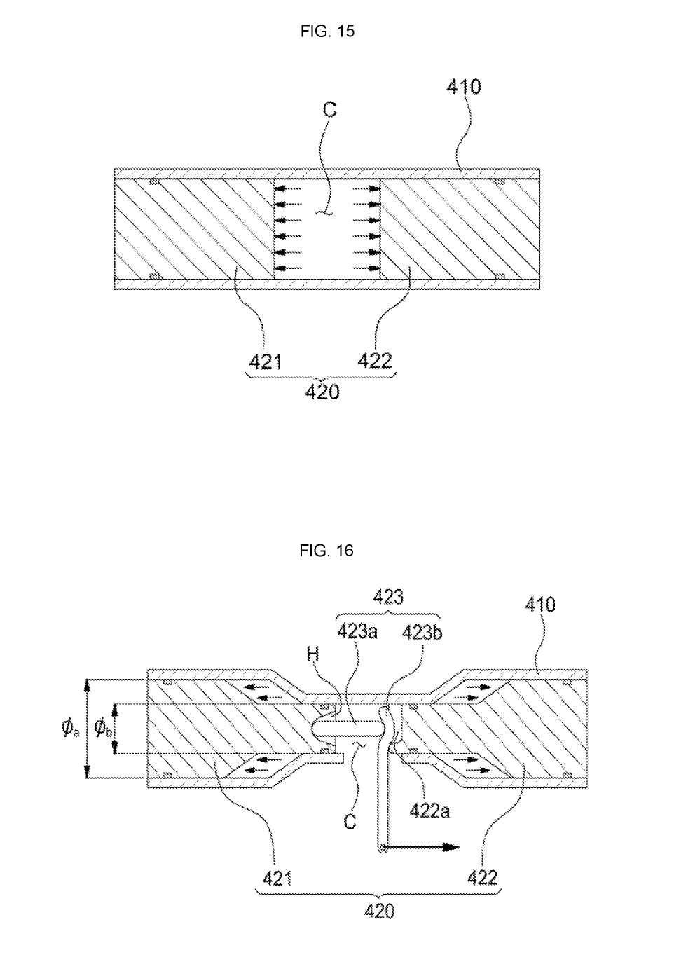

FIG. 14 shows the brake apparatus of the single shoe type according to the sixth embodiment of the present disclosure. FIG. 15 is a conceptual diagram showing the actuator for the brake apparatus of leading shoe and trailing shoe type according to the prior art. FIG. 16 shows the operation of the piston in the parking brake operation for the brake apparatus of the single shoe type, according to the sixth embodiment of the present disclosure.

Generally, the brake hydraulic pressure generated in operation of the main brake is generated inside the actuator 400. Thus, the braking force is generated by expanding the single-type brake shoe 100, as shown in FIG. 14, via the independently formed piston 420 without the operation of the parking lever 423 of the parking brake. In this case, referring to FIG. 14, the brake of single type shoe has high brake boosting performance. Thus, the braking force thereof is much higher than the conventional leading shoe and trailing shoe type brakes. Therefore, at the time of braking, the brake may be fastened to the rear wheels prematurely. As a result, frequent operation of the ABS occurs. Therefore, the braking force of the single shoe type main brake should be reduced to the level of the braking force of the leading shoe and trailing shoe type brake.

Thus, as shown in FIG. 16, the piston is constructed as follows so that the actuating force of the actuator 400 consisting of the hollow cylinder 410 and the piston 420 is reduced: the structure of each of step-shaped pistons 421 and 422 is applied. That is, the piston has a step. That is, the outer diameter of each piston is divided into a small Φ_{b} portion and a large Φₐ portion. Accordingly, the piston actuating force is reduced to π/4Φₐ²−π/4Φ_{b}². Therefore, the braking force of the single shoe type main brake may be reduced to the level of the braking force of the leading shoe and trailing shoe type brake.

As shown in FIG. 15, when applying the non-stepped pistons 421, 422, the outer diameter of the piston 420 must be reduced in order to reduce the actuating force of the piston 420. If the outer diameter of the piston 420 decreases, this disallows configuration of the parking brake as shown in FIG. 16. As a result, as shown in FIG. 14, in the structure of the single brake shoe 100 and the actuator 400, there is no separate fixing anchor to support the conventional leading shoe and trailing shoes. Therefore, during braking, the boosting action increases, and the braking force is amplified.

That is, the brake of single type shoe has high brake boosting performance. Thus, the braking force thereof is much higher than the conventional leading shoe and trailing shoe type brakes. Therefore, at the time of braking, the brake may be fastened to the rear wheels prematurely. As a result, frequent operation of the ABS occurs. Therefore, the braking force of the single shoe type main brake should be reduced to the level of the braking force of the leading shoe and trailing shoe type brake. For this reason, according to the present invention, the piston 420 of the actuator 400 has a step-shape. As a result, liquid pressure for braking acts only on an area obtained by subtracting the area of the small outer diameter from the area of the large outer diameter (π/4πₐ²−π/4Φ_{b}²). Therefore, braking force reduction may be possible.

The actuator 400 may include a hollow cylinder 410 and a piston 420.

The hollow cylinder 410 is installed in the spacing A of the single brake shoe 100, as shown in FIG. 14. The hollow cylinder 410 has a piston accommodation space C defined therein.

The piston 420 is accommodated inside the accommodation space C. A pair of pistons 422 and 421 may be received in the cylinder. The pistons may be spaced apart from one another. When the hydraulic pressure is generated by the operation of the brake, each separated end of the single brake shoe 100 may be pressed by each piston to create a braking force.

In this connection, the braking force generated as described above varies in proportion to the area of the piston 420. Thus, by selectively combining the areas of the pistons 420, it is possible to reduce the braking force during brake operation. Meanwhile, the actuator 400 installed in the parking brake according to the present embodiment may further include a parking lever 423. Accordingly, by operating the actuator 400 and the parking lever 423 in a cooperated manner, a braking force may be effectively generated when the parking brake is operated. To this end, the piston 420 according to the present embodiment has a first piston 421, a second piston 422, and the parking lever 423 may be operatively coupled to the first and second pistons, as shown in FIG. 16.

The first piston 421 is disposed in a first portion of accommodation space C. The first piston has a accommodation groove H having a predetermined size.

Further, the second piston 422 is disposed in the second portion of the accommodation space C, and the first portion and the second portion are opposed to each other. The second piston is spaced apart from the first piston 421. The second piston has a reaction-force generation groove 422a formed at a position facing the accommodation groove H provided in the first piston 421.

The parking lever 423 may be installed on the rear wheel side of the vehicle. The parking lever may be configured to separate the interval between the first piston 421 and the second piston 422 during operation of the parking brake. Each of the first piston 421 and the second piston 422 push each of separated ends of the single brake shoe 100, creating a braking force.

The parking lever 423 includes a first actuation link 423a and a second actuation link 423b so that the above operation may be performed.

The first actuation link 423a has a predetermined length along the horizontal direction and is partially inserted into the accommodation groove H.

Further, the second actuation link 423b has a predetermined length along the horizontal direction. The second link extends perpendicular to the first actuation link 423a. The end of the second link is operably engaged with the end of the first link. The end of the second link facing the end of the first actuation link 423a is rounded to correspond to the shape at the end of the first actuation link 423a.

The rounded end of the second actuation link 423b is disposed inside the reaction-force generation groove 422a. In operation of the parking brake, the second link 423b pivots, thereby pressing the first actuation link 423a, thereby increasing the spacing between the first piston 421 and the second piston 422.

That is, when the parking brake is activated, the second actuation link 423b pivots about the other end thereof. At this time, the rounded end of the second actuation link 423b pushes the first actuation link 423a in the horizontal direction, and, thus, the first piston 421 moves in the horizontally.

As a reaction against such movement, one end of the second actuation link 423b is pivoted to push the second piston 422, and, thus, the second piston moves in the direction opposite to the first piston 421. Thereby, the first piston 421 and the second piston 422 are spaced apart from each other.

Accordingly, the first piston 421 and the second piston 422 push the respective separated ends of the single brake shoe 100, and a braking force is generated. This eliminates the need for the conventional leading shoe and trailing shoe and the fixing anchor connecting them. Therefore, the parking lever 423 may be easily installed, so that the single shoe type brake may be used as the parking brake.

According to the present disclosure, the actuation-force reducing groove is formed in the inner face of the brake shoe with spacing defined therein at a predetermined position to reduce the actuation-initiating force which is, otherwise, rapidly increased due to wear of the brake lining. The expansion and deformation of the brake shoe at the wear of the brake lining occurs from the actuation-force reducing groove, thereby reducing the expansion force for the single shoe type.

In accordance with the present disclosure, the brake apparatus has a single type shoe to allow removal of anchors that support the leading shoe and trailing shoe; a parking lever and actuator cooperate with each other to increase parking braking force, the boosting is enabled and thus the braking force is amplified when the parking brake is actuated, in using the single shoe type brake as the main brake; a step-shaped actuator is placed in the spacing defined in the brake shoe, such that it is possible to reduce the braking initiation force of the main brake mounted on the rear wheel and prevent the problem that the ABS frequently operates when the brake on the rear wheel shaft prematurely.

While the foregoing description of the present disclosure has been provided with reference to preferred embodiments of the present disclosure, those skilled in the art will appreciate that various modifications and changes may be made to the present disclosure without departing from the spirit and scope of the present disclosure set forth in the claims that follow.

What is claimed is:

1. A brake apparatus comprising:
a single monolithic brake shoe having a circular shape, wherein the shoe has a spacing defined therein at a predetermined location thereof;
an actuator disposed in the spacing, wherein the actuator includes a hollow cylinder and a piston slidably contained in the cylinder, wherein when the actuator is activated, the spacing increases; and
a brake lining lined on an outer face of the brake shoe, wherein when the spacing increases, the lining selectively contacts a brake drum,
wherein the piston is step-shaped such that a braking force of the brake apparatus having the single monolithic brake shoe is substantially equal to a braking force of a brake apparatus having two individual brake shoes.

2. The apparatus of claim 1, wherein the brake shoe has an actuation-force reducing groove defined therein at a second location thereof, wherein the groove is defined in an inner face of the shoe facing the spacing, wherein the first location is opposite to the second location.

3. The apparatus of claim 2, wherein the brake shoe has a circumference face portion, and both radially and inwardly extensions from both edges of the face portion respectively, wherein the groove is defined in at least one of the radially and inwardly extensions, wherein when the grooves are defined in the radially and inwardly extensions respectively, the grooves have the same or different depth and/or shape.

4. The apparatus of claim 2, wherein the actuation-force reducing groove has convex and concave portions, or corrugations or is step-shaped or has a rounded shape, wherein a shape of the groove depends on a performance of the brake apparatus.

5. The apparatus of claim 2, wherein a thickness of the shoe is h in a region where the actuation-force reducing groove is not formed, wherein in a region of the actuation-force reducing groove, a thickness of the shoe is h1, wherein a depth of the actuation-force reducing groove is h2, wherein ⅓<h2/h1<3.

6. The brake apparatus of claim i, further comprising a fixing unit configured to prevent an upward movement of the shoe when the actuator is activated and thus the shoe expands.

7. The brake apparatus of claim 2, further comprising a fixing unit configured to prevent an upward movement of the shoe when the actuator is activated and thus the shoe expands.

8. A brake apparatus comprising:
a single monolithic brake shoe having a circular shape, wherein the shoe has a spacing defined therein at a first location thereof; and
an actuator disposed in the spacing, wherein the actuator includes a hollow cylinder and a piston slidably contained in the cylinder, wherein when the actuator is activated, the spacing increases;
wherein the brake shoe has an actuation-force reducing groove defined therein at a second location thereof, wherein the groove is defined in an inner face of the shoe facing the spacing, wherein the first location is opposite to the second location.

9. The apparatus of claim 8, wherein the piston includes first and second pistons spaced apart from each other, wherein when a hydraulic pressure is generated by an operation of the brake apparatus, each separated end of the single brake shoe via the spacing is pressed by each of the first and second pistons.

10. The apparatus of claim 9, wherein combination of diameters of the first and second pistons is configured such that a braking force of the brake apparatus is reduced when the brake apparatus is activated.

11. The apparatus of claim 9, wherein the hollow cylinder has an accommodation space defined therein, wherein the space is divided into a first space and a second space arranged in a longitudinal direction of the cylinder, wherein the first and second pistons are slidably received in the first and second spaces respectively,
wherein the first piston has an accommodation groove having a predetermined size,
wherein the second piston has a reaction-force generation groove formed at a position facing the accommodation groove provided in the first piston,
wherein the apparatus further includes a parking lever, wherein the parking lever is configured to allow and control a spacing between the first piston and the second piston during operation of the brake apparatus as a parking brake.

12. The apparatus of claim ii, wherein the parking lever includes a first actuation link and a second actuation link,
wherein the first actuation link has a predetermined length along a horizontal direction and has one end inserted into the accommodation groove,
wherein the second actuation link has a predetermined length along a vertical direction, wherein the second link extends perpendicular to the first actuation link,
wherein one end of the second link is operably engaged with the other end of the first link, wherein said one end of the second link is received in the reaction-force generation groove,
wherein in an operation of the apparatus as a parking brake, the second link pivots around the other end thereof, thereby pressing the first actuation link, thereby increasing the spacing between the first piston and the second piston.

13. The apparatus of claim ii, wherein each of the first and second pistons is step-shaped such that each of the pistons has portions with different diameters.

14. The brake apparatus of claim 8, further comprising a fixing unit configured to prevent an upward movement of the shoe when the actuator is activated and thus the shoe expands.

15. The apparatus of claim 8, wherein a thickness of the shoe is h in a region where the actuation-force reducing groove is not formed, wherein in a region of the actuation-force reducing groove, a thickness of the shoe is h1, wherein a depth of the actuation-force reducing groove is h2, wherein ⅓<h2/h1<3.

16. The apparatus of claim 8, wherein the actuation-force reducing groove has convex and concave portions, or corrugations or is step-shaped or has a rounded shape, wherein a shape of the groove depends on a performance of the brake apparatus.
